(19) United States
(12) Patent Application Publication
(10) Pub. No.: US 2003/0049014 A1
(43) Pub. Date: Mar. 13, 2003

(54) Method and apparatus for playing digital media and digital media for use therein

(75) Inventor: Najmul H. Siddiqui, Markham (CA)

Correspondence Address: MAYER, FORTKORT & WILLIAMS, PC, 251 NORTH AVENUE WEST, 2ND FLOOR, WESTFIELD, NJ, 07090, US

(73) Assignee: Tri-Vision Electronics Inc.

(21) Appl. No.: 09/948,951

(22) Filed: Sep. 7, 2001

(51) Int. Cl. H04N 5/76; H04N 5/781

(52) U.S. Cl. 386/46; 386/69; 386/125

(57) ABSTRACT

A method and apparatus for enabling a viewer to deselect certain portions of programming the viewer finds objectionable enable the viewer to skip over scenes in a digital media program that the viewer finds objectionable. Alternatively or in addition to, some embodiments enable the viewer to select alternative scenes of the same program recorded by the producer that do not include the objectionable material. A computer readable media has encoded thereon predetermined navigational threads that tell a playback device the proper sequence of program segments to play to meet a user specified content rating threshold.

### BACKGROUND OF THE INVENTION

The present invention relates generally to methods and apparatuses for enabling users to control the content of media programs being viewed, and more particularly to a method and apparatus for enabling a user to control the content of a media program being viewed when played on a digital media player.

Digital Video Disks (DVDs) are a popular way of viewing movies, concerts, video games or other pre-recorded programs. The original producer of the programming contained on a DVD usually is the entity that records the DVD. These programs are often rated under one or more ratings systems to allow viewers to block objectionable programming using V-Chip technology, such as that disclosed in U.S. Pat. No. 5,828,402, which patent is hereby incorporated by reference as if repeated herein in its entirety, including the drawings. U.S. patent application Ser. No. 09/694,778 is directed to a universal ratings system for use in such devices, which is hereby incorporated by reference as if repeated herein in its entirety, including the drawings.

While these programs are rated for overall content, often the programs receive a particular rating for a relatively small number of scenes (either video or audio or both) contained in the program. Moreover, producers often create alternative versions for use in other venues where the audience is not controlled, such as airplanes. In fact, many times alternative scenes of movies are shot and then edited in or out to obtain specific ratings. However, these alternative versions are not often provided to the general public due to distribution costs, etc. Sometimes newer DVDs will contain extra scenes not included in the original production, however, these are not included in the sequence, but are additional scenes one can view out of sequence.

For those parents or users that wish to control objectionable programming to something below PG-13, for example, there are fewer and fewer programs available to watch on DVD, as producers often include sufficient levels of sexual and violent content to receive a PG-13 or R rating, as the marketing analysis tends to show that movies with these ratings often gross more than movies with lower ratings, such as G and PG. Moreover, parents often face a catch-22, in that they wish to allow their children to view a popular movie, but the movie contains a few scenes that the parents feel is inappropriate for their children. By not allowing the children to view the movie, the children feel isolated from their peers and often become subject to intense peer pressure, which the children in turn reflect back to the parents. Thus, the parents must choose between isolating their children from their peers and maintaining their stand vis-a-vis objectionable programming.

The present invention is therefore directed to the problem of improving the quantity of programs available to viewers that prefer to limit the content of the programs they view and providing the viewers control over the content of such programs.

### SUMMARY OF THE INVENTION

The present invention solves this and other problems by providing a method and apparatus for enabling a viewer to deselect certain portions of programming the viewer finds objectionable. For example, the certain embodiments enable the viewer to skip over scenes in a digital media program that the viewer finds objectionable. Alternatively or in addition to, other embodiments enable the viewer to select alternative scenes of the same program recorded by the producer that do not include the objectionable material.

### BRIEF DESCRIPTION OF THE DRAWINGS

FIG. 1 depicts an exemplary embodiment of a sequence of programming segments and a navigational flow of the segments based on a content code associated with each segment and a user preference for use in a computer readable media or DVD or other playable media.

FIG. 2 depicts a flow chart of one exemplary embodiment of the present invention for use by a processor or decoder or DVD player according to another aspect of the present invention.

FIG. 3 depicts an exemplary embodiment of a device for playing back a digital media according to yet another aspect of the present invention.

FIG. 4 depicts an exemplary embodiment of a computer readable media according to one aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In general, the present invention includes methods and apparatuses for enabling a viewer to control the playback of programming on a digital media (e.g., a DVD) so that the viewer can control the amount of objectionable programming. More specifically, the present invention enables the user to navigate or “reprogram” a DVD, for example, to play only those scenes in the program that meet with the user's preferences, which are entered in the form of viewing preference thresholds, such as a content rating system that can be decoded by a V-Chip decoder. The content ratings are used to navigate either on an instantaneous basis or by queuing up scenes in advance that meet the preferences set by the user. In the embodiments in which scenes are queued up in advance, the processor may continue working in the background to identify future scenes in the sequence as set forth by the producer in accordance with the methods disclosed herein.

There are many possible ways to implement the various aspects of the present invention. One exemplary embodiment includes a DVD player that is programmed in accordance with the methods described herein. In this case, the control processor of the DVD player performs the methods described herein.

Another exemplary embodiment comprises a computer that has a program that plays media files in accordance with the methods described herein. In this case, the computer's main processor performs the methods described herein under control of a software program.

Yet another exemplary embodiment comprises a computer readable media itself, which has several navigational threads (e.g., directories or tracks) that can be selected, each of which has a content rating associated with it. These threads are essentially navigational indicators that tell the DVD player how to replay the sequence of scenes stored thereon to meet the user's viewing preferences. In this embodiment, there is no processor that performs a method, but rather the method is performed in the way the DVD player is originally configured. For example, one thread could have a content rating of R; another thread could have a content rating of PG, etc. Some scenes in each thread would be the same, whereas other scenes would be different (even if mildly different). Thus, to save space the media may store only a single version to which two separate threads point. By carefully editing a program rated R, one may create the same program with a PG-13 rating, or even a PG rating. Often, programs include only a few scenes that would convert a PG rated program to a PG-13 rated program or even to an R rated program. Thus, the threads represent the result of an editing process to enable one to navigate through a program so that the content of the program meets the user specified content rating thresholds. The threads may simply be pointers to various segments of the program that piece together scenes of the program in a way that does not violate the user's specified content rating threshold. For example, each programming segment may contain a header and footer that indicate the start and stop of a program segment and its associated content. Once a particular navigational thread is selected a pointer tells the player which program segment to play based on a table stored in the media. The table lists the program segments in sequence, so that the player plays the first listed program segment, then the second program segment in the table and so on. Each column or row in the table is associated with a particular rating content. For example, column one could include program segments that do not exceed PG. The next column could include program segments that do not exceed PG-13. And so on, until there is a column for each possible rating up to the level of the original program.

Yet another exemplary embodiment includes a computer readable media that has the same program in its entirety stored on the media in several versions. In this embodiment, the raw data disc may be manufactured (e.g., printed) or recorded by the producer to include several versions of the same program but with different ratings, each of which may be selectable by the user based on its content rating. For example suppose a disc program is rated ‘R,’ the producer may have also an edited version on the disc similar to an EDITED for TV movie that the user can select a ‘PG’ or ‘G’ edition, all on this one disc. By providing the user the capability to select the program based on the content rating, one would be implementing one of the methods disclosed herein.

User Interface

One possible implementation of the user interface in an exemplary embodiment of the present invention consists of an On-Screen Display via which a user can enter his viewing preferences by highlighting a menu item using a remote control. For example, a list of ratings available for the particular digital media is displayed to the user, from which list the viewer can select a rating that the viewer desires to satisfy while viewing the digital media. For example, the program may display R, PG-13 and PG. The user interface may also include the universal ratings systems set forth in the patent applications previously incorporated by reference (U.S. patent application Ser. Nos. 09/586,268 and 09/694,778), in which the user dials up a rating preference based on some relative indication of content from one extreme to the other.

In another exemplary embodiment of the user interface, if the OSD is not available or quits the user has an alternate means to view or know what level they are at. This could include several possible implementations. For example, the remote control may include a flashing button that informs the users as to the content they are viewing. Another possible implementation includes a read out on the media player. Yet another possible implementation includes a user informational message or device placed on the television screen, such as an icon. This message or device could be placed on the display screen when a program is being played, e.g., an icon disposed in one corner of the display screen, or on an off-program portion of the display, such as underneath the programming so that it does not interfere with the viewing.

Signal Processing

One exemplary embodiment of the signal processor used in the present invention consists of an MPEG decoder, such as an MPEG-2 decoder. Other version of the signal processor could include an MPEG-3 or MPEG-4 decoder, for example. These decoders can decode embedded V-Chip ratings codes, which are embedded in various places in the digital bit stream. Certainly, other decoding schemes are possible as well, such as other content related codes that are included as a header or other file flag or attribute.

Alternatively, a sequence of program segments that meets each content code or rating could be stored and then selected by the processor once the processor determines the user's content preferences. For example, a sequence of scenes, each of which is numbered with a unique number could be selected that meets a particular rating content, such as PG-13. If the user selected another ratings preference, e.g., R, another predetermined sequence with content satisfying this selection could be enabled.

Storage

When playing back a digital media file, the time is independent from the picture data. In other words, one can buffer the picture data while the processor performs its calculations. By adding a buffer between an output of the video decoder, one can create the scene sequence one desires without disturbing the viewing of the program. A random access memory may be used to store the user's viewing preferences for subsequently viewing different digital media. Once the viewer has established preferences for a particular playback device, these preferences could be employed for subsequent viewings. Moreover, a password could be used to lock out other users from modifying the viewing preferences, if desired.

Signal Reconstruction

Each subset of the program includes a program code that represents the content of the program for the subset. One possible subset could be scene by scene, or every 5 seconds. As the program unfolds, the processor compares the embedded program code for a given subset of the program against the previously entered viewing preferences. If a particular program subset is rated above the rating set by the user, then several actions can be taken by the processor.

First, the scene may be skipped entirely without notifying the viewer so that the program appears continuous. This could be the case, where the scene has no alternative included in the media.

Second, the scene may be replaced by an alternative scene that has a lower rating that satisfies the viewer preferences. For example, during a scene with sexual content the lights could be dimmed so that little is shown and what remains satisfies a PG rating rather than an R rating. This scene would be included with the programming and encoded with the program so that the processor would simply cut the scene with the higher rating, add the scene with the appropriate rating and present the result to the viewer. As the timeline of the program is controlled by the media player, even if the scene are not the same in time, the program remains in sequence without being disruptive to the viewer. In this version, a user activatable text message can be included at the bottom of the screen indicating to the user that an alternative scene was substituted.

Third, the scene can be blanked letting the viewer know that the particular scene was edited.

Thus, the present invention enables a producer of a digital media to make his or her program available to as wide an audience as possible, thereby increasing the potential revenue available to a given production.

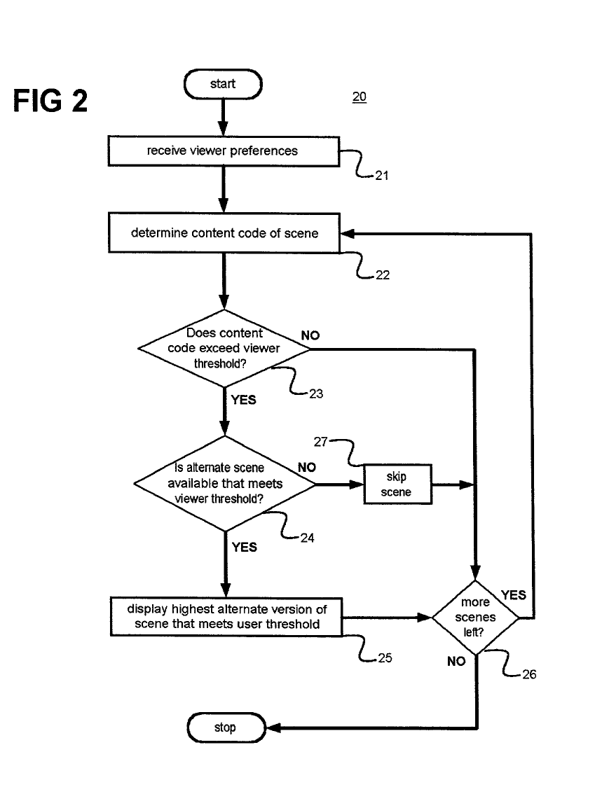

FIG. 2 depicts an exemplary embodiment 20 of a method for performing the playback of a digital media using the above technique. In activity 21, the user's viewing preferences are received by the playback device, which could be a decoder, television, VCR, DVD player, computer, processor or other media player. These preferences could have been entered earlier and stored in memory, or obtained in response to a query by the playback device.

In activity 22, as each scene is received for display, the device checks the content code of the scene. One possible technique is to decode the embedded V-chip rating in the media. Alternatively, the scene could simply have an associated label that indicates the content.

In activity 23, the content code is compared to the user preference threshold. If the scene's content code exceeds the user preference threshold, the process moves to activity 24. The content code can be compared using a simple comparator or other logic device. If the content code does not exceed the viewer's preference threshold, then the process moves to activity 26 and checks for more scenes.

In activity 24 the alternative scenes are checked to determine if there is one whose content code meets the viewer's preference threshold. If an alternative scene exists that meets the viewer's preference threshold, then the process moves to activity 25. If there is no alternative scene available that meets the user's viewing preference threshold, then the process moves to activity 27 and skips the scene. The process then moves to activity 26 to check if there are more scenes remaining.

In activity 25, the alternative scene with the highest rating that meets the viewer's preference threshold is selected for display. If there are multiple scenes available, the scenes may be ranked in a hierarchy and then tested moving from the highest rated alternative scene down until one meets the viewer's threshold preference.

In activity 26, the player determines whether any scenes or program segments remain. If so, the process returns to activity 22 to check the content code for the next scene. If not, the process ends.

While the above embodiment is described in a linear process, some of the steps may be implemented in advance. For example, once the viewer's preference threshold is known, the sequence of scenes can be determined (e.g., by the above or a similar process) and then stored in a buffer that controls a pointer to the next scene to display. In a DVD player for example, moving between scenes is faster than the human eye can determine, which means that scenes can be skipped or replaced without appearing disruptive to the viewer.

Moreover, while the above embodiment is described in terms of video or images, the above process could involve audio portions. For example, substitute audio could be stored on the media that is actuated when language content ratings exceed the user's preferences. Alternatively, the audio could be muted for a particular segment in such cases where alternative audio is not available.

Programming of the Digital Media

When producing a digital media that will operate with the apparatus of the present invention, the producer simply records alternative version of those scenes that may be rated with the highest ratings. For example, a producer may provide two versions for a particular scene, one having sexual content (which is rated R), and an alterative version that is only rated PG-13. The two scenes would be encoded in sequence on the digital media file.

When the processor controlling the playback of the digital media file decodes the scene, it determines that two versions of the scene are provided. It then compares the user preferences, which have been previously entered, against the codes representative of the content of the two versions. If the user has not entered any preferences, the program selects one of the two scenes either at random, or in accordance with a preference set by the producer, e.g., one version could be set as the master, and another as the replacement. If the user has entered a preference, the user's preference is compared against the codes of the two versions. If the user's preference is higher (e.g., the user has entered a preference for R rated programs, and the two scenes are G and PG), then the processor includes the master scene, for example. If the user's preference is below one of the two scenes, then the scene meeting the user's preference is selected for display. If more than one version meet the user's preference, but the master does not, then the processor displays the scene with the highest rating that meets the user's preference. If no version meets the user's preference, then the scene may simply be skipped without disrupting the flow of the program to the viewer.

Computer Readable Media

According to another aspect of the present invention, an exemplary embodiment includes a computer readable media that has been programmed to link alternative segments of the program together, in which a rating code is used to navigate the links within the computer readable media. Possible embodiments of the computer readable media include DVDs, CDs, VCR tapes, memory chips, memory sticks, flash memory, etc.

According to this embodiment, the processor controlling the playback of the computer readable media decodes the embedded ratings code within each program segment. The processor then compares the decoded ratings code against a stored user preference. If the segment is rated with a code that is acceptable to the user (based on the stored user preference), the processor displays the segment. If the segment is not acceptable to the user, the processor checks for alternative segments. If one or more alternative segments are stored on the computer readable media, the processor selects the segment having the highest ratings code that meets with the user's stored preferences, and displays that segment. If there are no alternative segments that meet the user's stored preferences, the processor simply skips to the next segment and repeats the same process.

For example, if a program segment includes an R-rated segment, but the user has entered PG-13 as the viewing preference, the processor will look for alternative segments that are rated G, PG or PG-13. If the processor finds an alternative segment that is rated PG and another one rated PG-13, the processor will display the segment rated PG-13. If the processor cannot find a segment rated less than R, the processor will skip to the next segment that is less than R-rated.

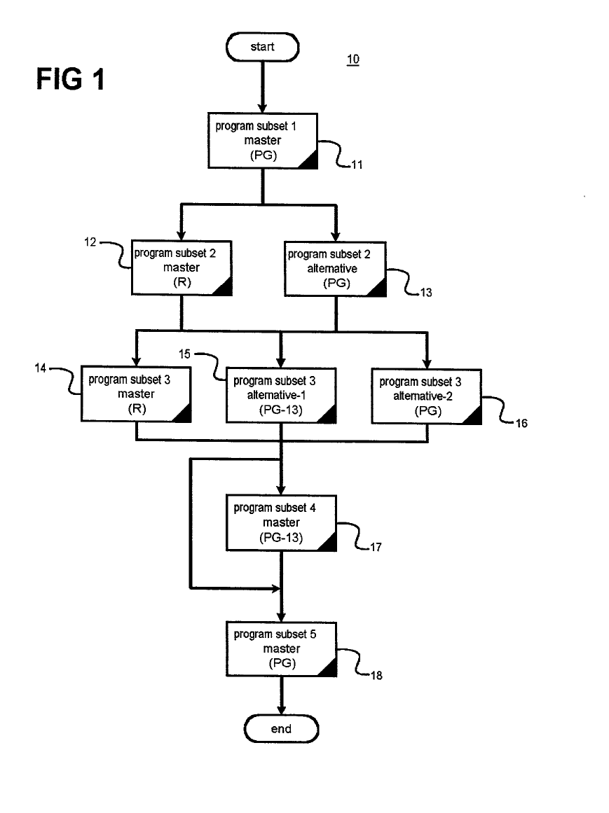

An exemplary embodiment of this process is shown in FIG. 1, which shows an example of a computer readable media that has stored thereon five program subsets. Each of which is rated for content. Program subsets one 11, four 17, and five 18 do not have alternative versions. Program subset two has a master version 12 and an alternative version 13. Program subset three has a master version 14 and two alternative versions 15, 16.

If the user selects a preference of R rating as the threshold, then the sequence of program subsets 11, 12, 15, 17 and 18 is displayed to the viewer. This is the original rating of this program so all of the master versions of the scenes are displayed.

If the user selects a preference of PG-13 rating, which is a lower rating than the original rating of the program, then a sequence of program subsets 11, 13, 15, 17 and 18 are displayed to the viewer. In this case, in program subset two, the alternative version 13 is displayed instead of the master version 12. In program subset three, program subset three alternative-1 15 is chosen for the display, as this version falls within the viewer's preference threshold and is the highest rated subset that does so (as compared to alternative-2 16).

If the user selects a preference of PG as the threshold, then a sequence of program subsets 11, 13, 16, and 18 is displayed. In this case, program subset four 17 is skipped since it exceeds the viewer's preference threshold and there is no alternative with a lower rating that meets the viewer's preference threshold. In program subset three, program subset three alternative-2 16 is chosen for the display, as this version falls within the viewer's preference threshold and is the highest rated subset that does so (none other are available).

According to one possible embodiment of this aspect of the present invention, the computer readable media includes blocks of programming, in which each block includes a header or flag that indicates its content. Another flag or header may also indicate the sequential relationship of the programming block, e.g., 0010M, which would indicate that this was the tenth programming block in the sequence and that it is the master programming block and therefore should be displayed unless the programming block's content rating fails to satisfy the user's preferences.

A table in the computer readable media may list the order of the programming blocks used to meet various content rating thresholds. The table then lists the location on the DVD of each of the programming blocks, which allows the player to sequentially select the appropriate programming blocks.

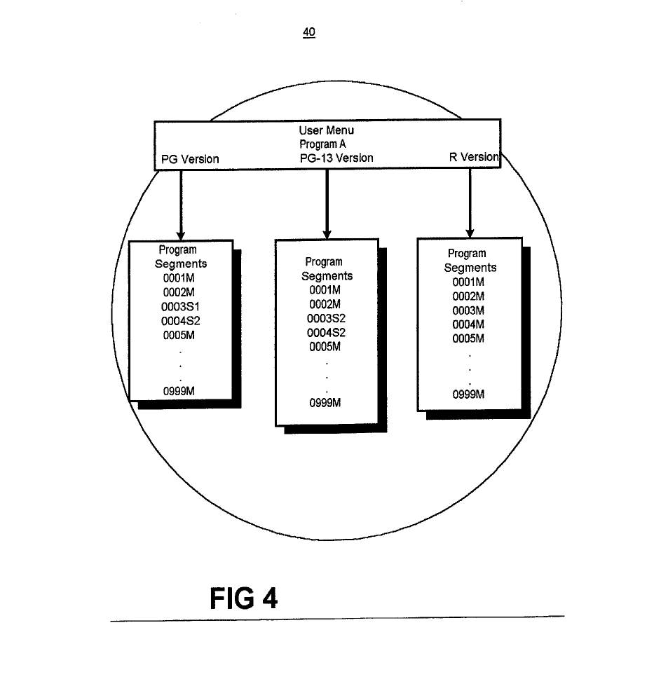

FIG. 4 depicts an exemplary embodiment of a computer readable media 40 according to one aspect of the present invention. The media 40 include a user interface menu that allows the user to select a content rated version of the program contained on the media. Once the user has selected a content rated version of the program, the media returns downloads the addresses associated with the selected version into the player, which then plays the program at the downloaded addresses in the sequence specified. In one possible embodiment, a single address is returned and the succeeding program at that address is played to its end. This embodiment removes the possibility of any artifacts being created in the program due to transitions between program segments.

According to another possible embodiment, multiple addresses are provided, and the player plays the programs in order at the specified locations until there are no more addresses remaining, at which point the program ends. This embodiment permits reusing of the same program blocks in different versions for those portions of the movie that are used in different versions, thereby saving space.

Decoder

According to an exemplary embodiment of the present invention, programmers encode information regarding a media program's content within the digital signal itself (e.g., an MPEG data stream). This information is then used to control that which is played on the media player. Each media programmer embeds periodic program codes in the program's data stream, which program code describes the content of the portion of the data stream, similar to that specified by EIA-608 recommended practice for line 21 data service on broadcast television.

In operation, the decoder compares the embedded program code with a classification guide and determines whether to display or to block a given media program. Although the decoder may be designed to include one or more preinstalled classification guides for the particular rating system(s) in use in the region or locality in which the decoder is located, the decoder may also be “self-configuring” such that it can download a specific classification guide from a television signal and use that information to display to the user the classification choices among which to select. This ability to “self-configure” enables the decoder to be independent of any particular broadcasting rating system, country regulations, or region or locality in which the decoder is located. Specific details of this capability are disclosed in U.S. Pat. No. 5,828,402, which is hereby incorporated by reference as if repeated herein in its entirety.

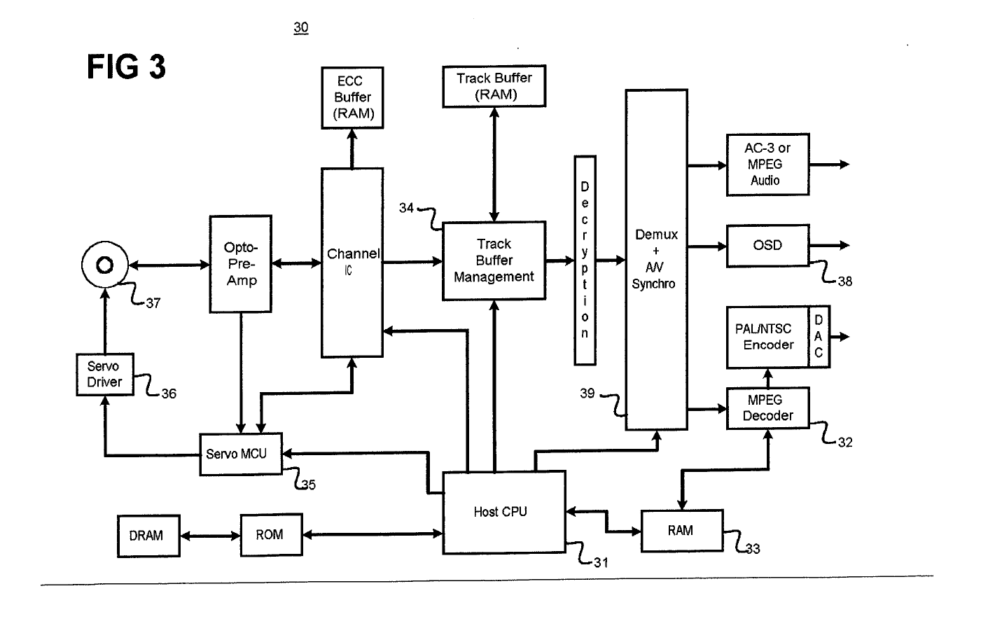

Turning to FIG. 3, an exemplary embodiment of a DVD player or the like is shown. The DVD player employs a processor 31 that controls the functions to perform the above-described methods. MPEG decoder 32 outputs the video data stream and associated metadata, which includes the V-Chip rating or other content code for the program subset. The memory 33 stores this video data and metadata for use by the processor 31. To select a different program subset, the processor 31 reads the header information and navigational information stored on the DVD 37, which tells the processor 31 the structure and format of the DVD 37 and the location of the various program subsets or segments on the DVD tracks. Then the processor 31 instructs the servo MCU 35 to move to the proper program section, which in turn operates the servo driver 36. Track buffer manager 34 interacts with the processor 31 to ensure the data is in the track buffer for immediate access by the processor. The host processor 31 interfaces with the Demux and A/V synchro 39 to create the On Screen Display 38 for use when interacting with the user to obtain the user viewing preferences.

### SUMMARY

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data formats and protocols, any formats or protocols may suffice. Furthermore, the example should not be interpreted to limit the modifications and variations of the invention covered by the claims but are merely illustrative of possible variations.

What is claimed is:

1. A method for playing a program stored on a digital media comprising:
receiving a user viewing preference content rating threshold; and
replacing a first subset of the program having a rating that fails to satisfy the user viewing preference content rating threshold with an alternative subset of the program, which has a rating that meets the user viewing preference content rating threshold.

2. The method according to claim 1, further comprising searching the digital media for an alternative subset of the program related to the first subset upon determining that the first subset fails to satisfy the user viewing preference content rating threshold.

3. The method according to claim 1, further comprising displaying the alternative subset of the program rather than the first subset.

4. The method according to claim 1, further comprising decoding a rating code embedded in the first program subset.

5. The method according to claim 4, further comprising comparing the decoded rating code against a stored user preference content rating threshold.

6. The method according to claim 5, further comprising storing the user viewing preference content rating threshold.

7. The method according to claim 1, further comprising decoding a ratings code for each of a plurality of subsets of the program throughout the playing of the program and replacing those of said each subset that fail to meet the user viewing preference content rating threshold with an associated alternative for said each subset that does meet the user viewing preference content rating threshold or skipping said each subset if there does not exist an associated alternative subset that meets the user viewing preference content rating threshold.

8. The method according to claim 1, wherein the first program subset includes both audio and video data.

9. The method according to claim 1, wherein the program subset includes only video data.

10. The method according to claim 1, wherein the program subset includes only audio data.

11. A method for playing a program recorded on a digital media comprising:
receiving a user viewing preference; and
skipping a first subset of the program having a rating that fails to satisfy the user viewing preference.

12. The method according to claim 11, further comprising decoding a rating code embedded in the first program subset.

13. The method according to claim 12, further comprising comparing the decoded rating code against a stored user preference.

14. The method according to claim 13, further comprising storing the user viewing preference.

15. The method according to claim 11, further comprising decoding a ratings code for each of a plurality of subsets of the program and replacing those of said each subset that fail to meet the user viewing preference with an associated alternative for said each subset that does meet the user viewing preference or skipping said each subset if there does not exist an associated alternative subset that meets the user viewing preference.

16. The method according to claim 11, wherein the program subset includes both audio data and video data.

17. The method according to claim 11, wherein the program subset includes only video data.

18. The method according to claim 11, wherein the program subset includes only audio data.

19. A method for recording a program on a digital media comprising:
encoding each of a plurality of subsets of the program with a code representative of a content of said each subset; and
recording on a same digital media one or more alternative versions of one or more of the plurality of subsets of the program, each of said one or more alternative versions of a same one of the plurality of subsets having a unique content code.

20. The method according to claim 19, further comprising decoding a rating code embedded in each of the plurality of program subset and replacing those of said each subset that fail to meet a user viewing preference with an associated alternative for said each subset that does meet the user viewing preference or skipping said each subset if there does not exist an associated alternative subset that meets the user viewing preference.

21. The method according to claim 20, further comprising comparing the decoded rating code against a stored user preference.

22. The method according to claim 20, further comprising storing the user viewing preference.

23. The method according to claim 19, wherein each of the program subset includes both audio data and video data.

24. The method according to claim 19, wherein at least one of the program subsets includes only video data.

25. The method according to claim 19, wherein at least one of the program subsets includes only audio data.

26. A computer readable media having encoded thereon:
a plurality of program segments arranged in a predetermined sequence, each of which plurality of program segments has associated therewith one or more content codes representative of a content of said each segment according to one or more ratings systems; and
a plurality of alternative program segments, each of which alternative program segments are replacements for one or more of the plurality of program segments, said each of the plurality of alternative program segments having a unique content code.

27. The computer readable media according to claim 26, further comprising instructions causing a processor to:
play a particular one of the plurality of programming segments if one or more content codes associated with the particular one of the plurality of programming segments fall within a range set by a user preference or select an alternative programming segment of the plurality of alternative program segments having one or more content codes that fall within the user preference range.

28. The computer readable media according to claim 27, further comprising instructions that further cause the processor to skip to a next programming segment in the sequence of the plurality of programming segments having one or more content codes that fall within the user preference range if there is no alternative programming segment associated with the particular one of the plurality of programming segments that has one or more content codes that fall within the user preference range and the code associated with the particular one of the plurality of programming segments exceeds the user preference range.

29. The computer readable media according to claim 26, further comprising a navigational pointer that enables a processor to navigate among the plurality of programming segments and the plurality of alternative programming segments without exceeding a user content preference.

30. The computer readable media according to claim 26, wherein the plurality of program segments and the plurality of alternative program segments include both audio and video.

31. The computer readable media according to claim 26, wherein at least one of the plurality of program segments and the plurality of alternative program segments include video segments only.

32. The computer readable media according to claim 26, wherein at least one of the plurality of program segments and the plurality of alternative program segments include audio segments only.

33. A computer readable media having encoded thereon:
a plurality of user selectable navigational threads, each of said threads having associated therewith a content rating designating a content threshold for said each thread; and
a plurality of program segments, wherein each of said user selectable navigational threads forms a unique sequence of a subset of the plurality of program segments.

34. The computer media according to claim 33, wherein the plurality of user selectable navigational threads includes a plurality of pointers designating a plurality locations on the computer readable media where the subset of the plurality of program segments are disposed.

35. The computer readable media according to claim 33, wherein the computer readable media comprises a DVD.

36. The computer readable media according to claim 33, wherein the computer readable media comprises a magnetic disk.

37. The computer readable media according to claim 33, wherein the computer readable media comprises an optical disk.

38. The computer readable media according to claim 33, wherein the computer readable media comprises one or more CD-ROMs.

39. The computer readable media according to claim 33, wherein the computer readable media comprises one or more memory sticks.

40. The computer readable media according to claim 33, having encoded thereon instructions that cause a processor to display one of the unique sequences upon selection by a user of a content ratings threshold.

41. The computer readable media according to claim 40, wherein the one unique sequence has a content rating that falls within the user established threshold.

42. The computer readable media according to claim 33, wherein at least one of the plurality of program segments includes a combination of audio and video.

43. The computer readable media according to claim 33, wherein at least one of the plurality of program segments includes only video.

44. The computer readable media according to claim 33, wherein at least one of the plurality of program segments includes only audio.

45. A computer readable media having encoded thereon:
a plurality of version of a program, each of said plurality of versions having an associated content rating; and
a user interface menu via which a user can select one of the plurality of versions of the program by the associated content rating.

46. The computer readable media according to claim 45, wherein the computer readable media includes a DVD.

47. The computer readable media according to claim 45, wherein the program includes a movie.

48. The computer readable media according to claim 45, wherein the program includes a video game.

49. The computer readable media according to claim 45, wherein the program includes a media program.

50. The computer readable media according to claim 45, wherein the content rating includes a V-Chip rating.

51. A method for encoding a computer readable media comprising:
encoding a plurality of versions of a same program on the same computer readable media, wherein each of the plurality of versions of the same program have associated different content ratings; and
encoding a user interface menu on the same computer readable media via which a user can select one of the plurality of versions of the same program by its associated content rating.

52. The method according to claim 51, wherein the computer readable media includes a DVD.

53. The method according to claim 51, wherein the program includes a movie.

54. The method according to claim 51, wherein the program includes a video game.

55. The method according to claim 51, wherein the program includes a media program.

56. The method according to claim 51, wherein the content rating includes a V-Chip rating.
